(19) United States
(12) Patent Application Publication
(10) Pub. No.: US 2003/0183249 A1
(43) Pub. Date: Oct. 2, 2003

(54) Method and system for cleaning beverage tubes and a detector unit used in the system

(76) Inventors: Jarmo Nissinen, Helsinki (FI); Esa Järvinen, Espoo (FI)

Correspondence Address: Christopher J Fildes, Fildes & Outland, Suite 2, 20916 Mack Ave, Gross Pointe Woods, MI, 48236, US

(21) Appl. No.: 10/297,069

(22) PCT Filed: Jun. 6, 2001
(86) PCT No.: PCT/FI01/00533

(30) Foreign Application Priority Data
Jun. 6, 2000 (FI) 20001347
Nov. 7, 2000 (FI) 20002431

(51) Int. Cl. B08B 9/027

(52) U.S. Cl. 134/22.11; 134/169 C

(57) ABSTRACT

The invention relates to a method and system for cleaning beverage tubes, in which the set of beverage tubes includes a set of tubes (17, 26) from a tank (30) to one or several dispensing devices (18), and possible cooling, amount calculating, or other devices (11, 12, 15, 16). The set of distribution tubes is cleaned in the following stages:—cleaning fluid is fed into the tubes from one end and the liquid already in the tubes is drained out of the opposite end,—the cleaning fluid is allowed to act for a set time,—the cleaning fluid is flushed out with flushing fluid by feeding in a corresponding manner in to the tubes and draining the cleaning fluid out,—the line is filled with the beverage being dispensed at the same time draining the flushing fluid out of the line. At each stage, each fluid is identified by means of its electrical properties from the end of the tubes opposite to the feed, and this feed is terminated by set criteria, after which the process goes on to the next stage.

The present invention relates to a method for cleaning beverage tubes, in which the beverage tubes comprise tubes from a tank to one or several dispensing devices and possible cooling, amount calculating, or other devices. The invention also relates to a detector unit used in the system.

The beverage tubes are cleaned in the following stages:

the cleaning fluid is fed into the tubes from one end and the existing liquid in the tubes is drained from the opposite end,

the cleaning fluid is allowed to act for period of time,

the cleaning fluid is flushed out with a flushing fluid which is fed in a corresponding manner into the tubes and the cleaning fluid is drained out,

the conduit is filled with the beverage to be dispensed while simultaneously draining the flushing fluid from the line.

At present, dispensing tubes are usually cleaned manually by detaching the main tank from the feed line and connecting cleaning fluid feed devices in its place. A suitable amount of cleaning fluid is circulated through the dispensing tubes for an appropriate time, after which the line is flushed for a suitable time with an appropriate fluid. This method is labourious and is also deficient in terms of the duration of the cleaning.

Beverages produced by yeast fermentation cause impurity problems in the beverage distribution systems of licensed restaurants. The collection of yeast-based bacteria in the conduits causes both health risks to those drinking the beverages and taste detriments in the beverages being dispensed. In particular, the equipment's tube bends and the discontinuous surface of the connectors collect impurities that cause the said detriments. In restaurants, it is usual to clean the distribution lines at intervals, by detaching the beverage tank from the feed line and replacing it with a cleaning fluid feed and a pump. Cleaning fluid is pumped into the distribution tubes and allowed to remain there for a certain time, after which the cleaning fluid tank is disconnected from the feed line and replaced with a flushing fluid tank, by means of which the cleaning fluid is flushed out of the distribution tubes into a drain connected to the system for this purpose. Both the flushing fluid tank and the pump used in cleaning are disconnected from the feed line and the main tank is connected to the feed line, which is once again filled with the beverage contained in the tank. This cleaning method, with its tanks and changes in valve positions, is often felt to be difficult and time-consuming, while it may result in deficient cleaning, depending on the actual time used for cleaning.

Automatic beverage tube cleaning systems are known from U.S. Pat. No. 4,527,585; Mirabile, U.S. Pat. No. 5,090,440; Ladoucer, and U.S. Pat. No. 5,762,096; Mirabile. The use of electrically operated valves allows the flow to directed through the tubes as desired. In the first of aforesaid publications, the duration of each stage is determined according to pre-programmed timing. Possible residues of flushing fluid are not detected, if these should appear, for example, due to a leaky valve. Otherwise, the cleaning of the distribution tubes can be programmed to be carried out for the desired time at the desired intervals, while the restaurant personnel can be relieved of the cleaning operation and its supervision.

The present invention is intended to create a new kind of method and system for cleaning distribution lines for alcoholic and other beverages. The characteristic features of the method according to the invention are stated in the accompanying claim 1. The characteristic features of one preferred system are correspondingly stated in claim 8, while the characteristic features of the detector unit relating to the system are stated in claim 13. The method and system according to the invention permit more reliable cleaning than before, because cleaning fluid cannot remain in the tubes after flushing, as it is possible to detect cleaning and flushing fluid. Cleaning fluid can appear due to either a valve failure or can remain in the tubes, due to an error, in a long ‘blind’ branch, from which the cleaning fluid cannot be flushed out. Preferably, the beverage being dispensed is also detected, the flow measurements being used to create an additional assurance. Dispensing points can be added to or removed from the distribution tubes, without altering the operation of the system in any way. The cleaning operation, with its emptying, dissolving, and flushing has been programmed in a standard form, and will remain unaffected by any factors caused by the actions of the personnel.

In the following, the invention is examined with reference to the accompanying drawings, which show some systems according to the invention, and their details.

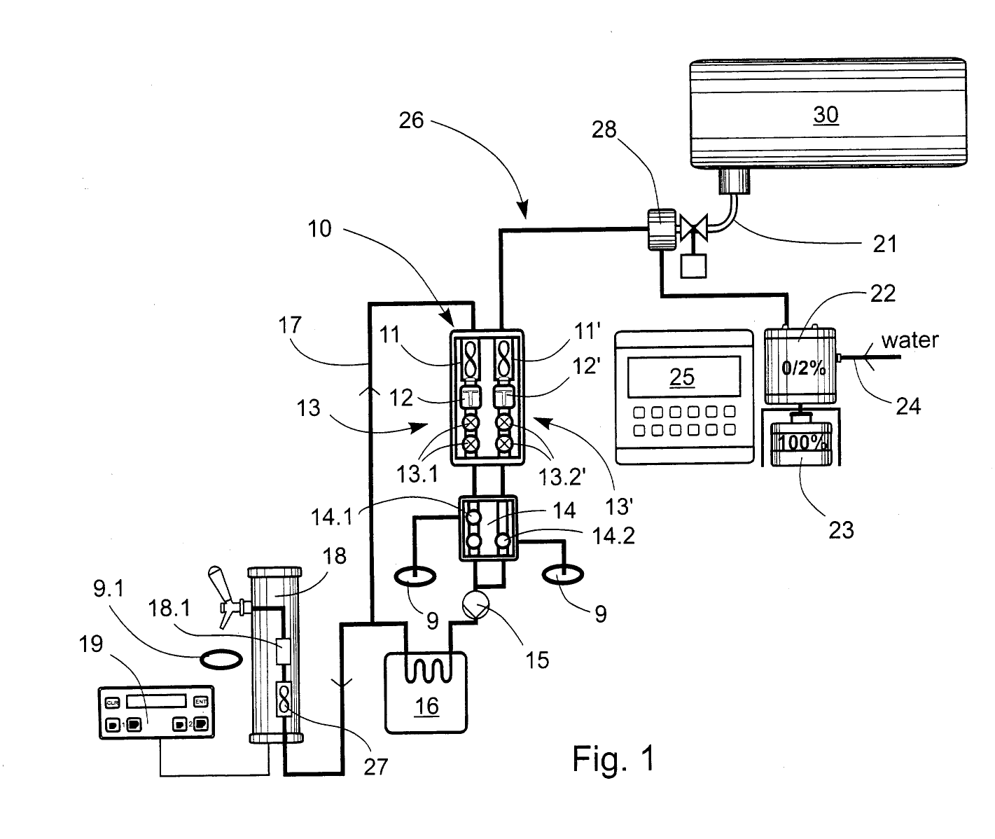

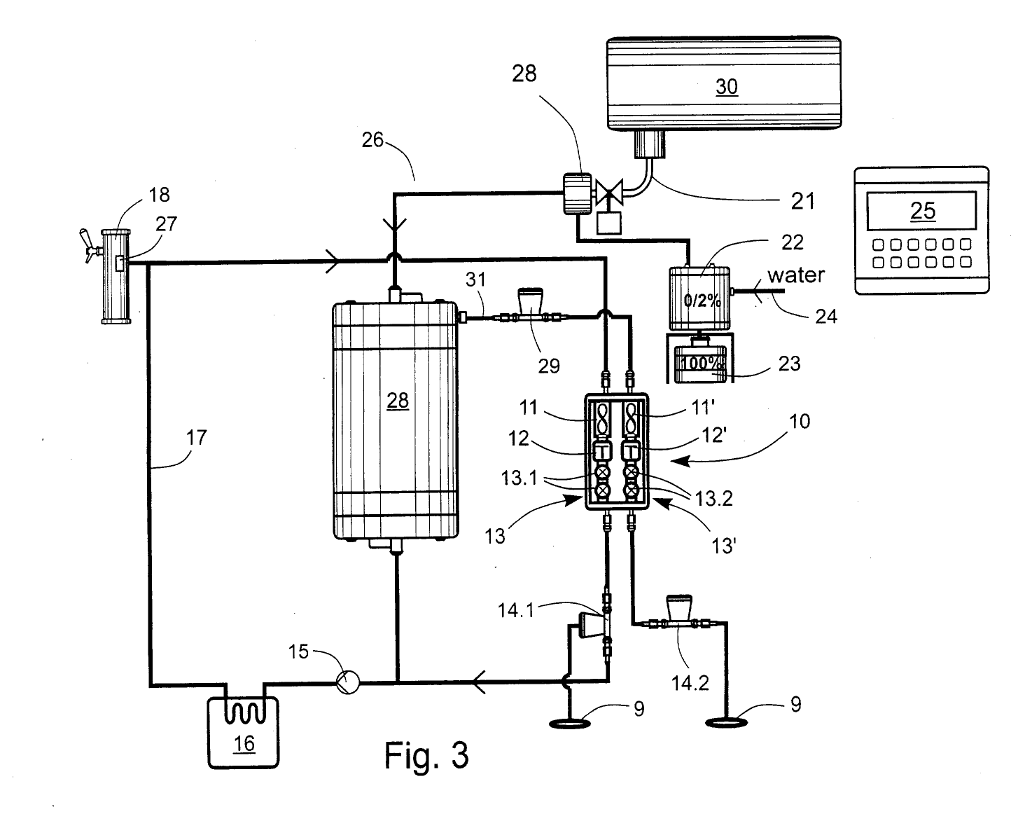

FIG. 1 shows a diagram of one set of distribution tubes equipped with a set of circulation tubes

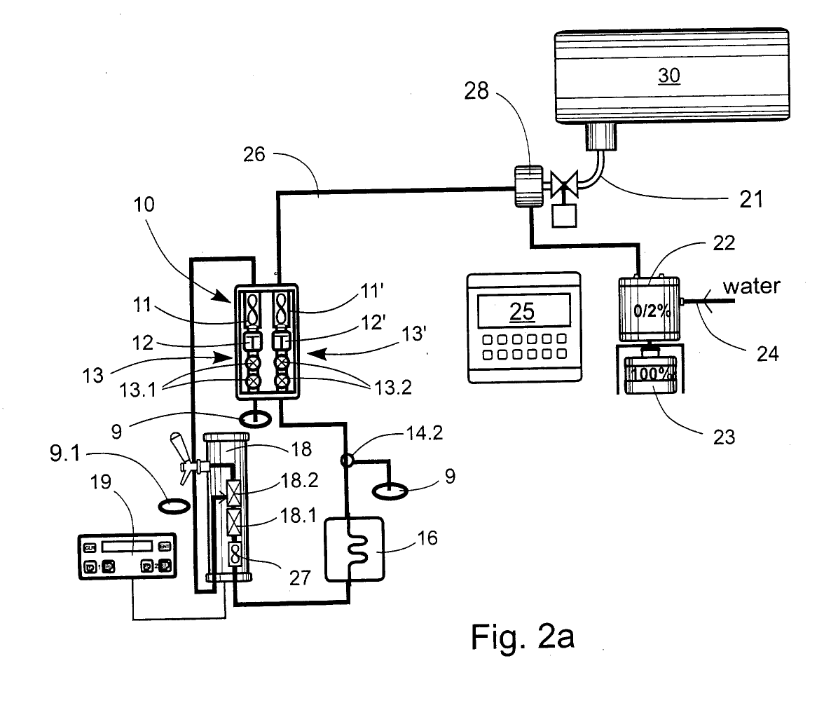

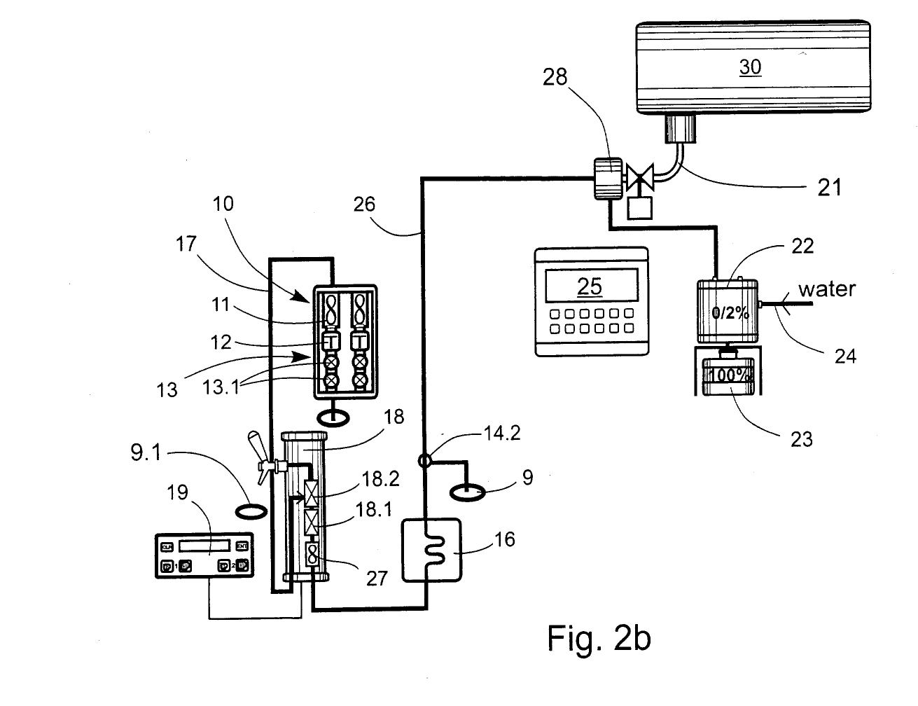

FIGS. 2a and 2b show a diagram of some straight distribution conduits

FIG. 3 shows a diagram of a conduit equipped with a foam detector

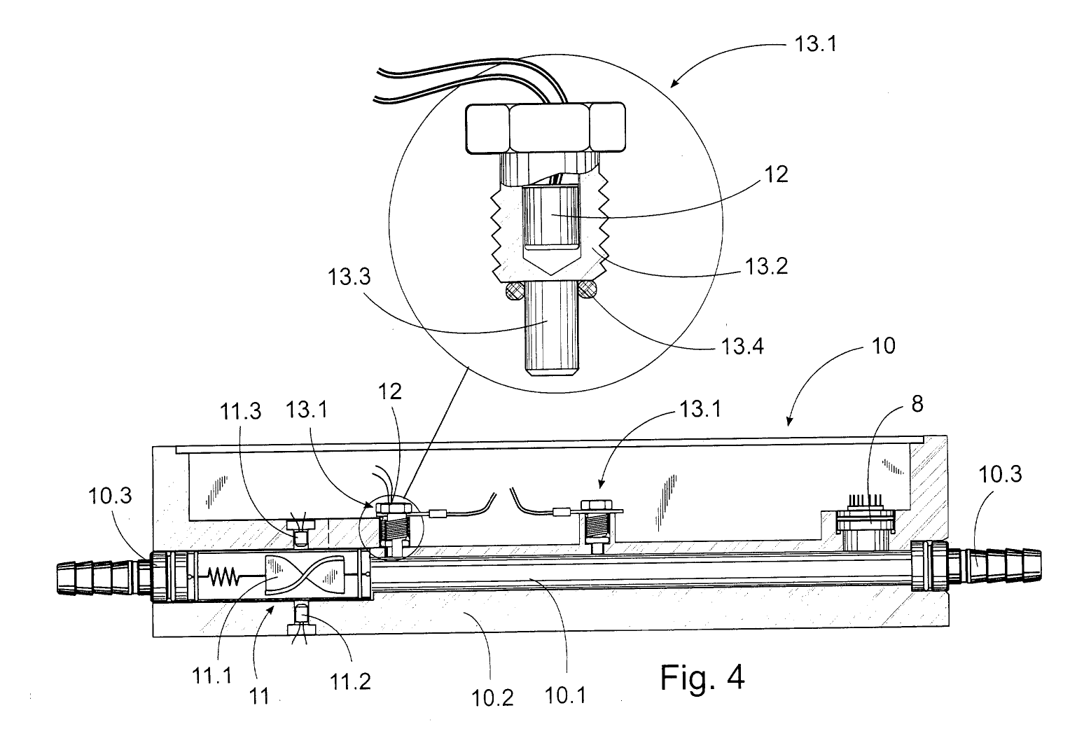

FIG. 4 shows a side projection of the detector unit, as a cross-section at the channel

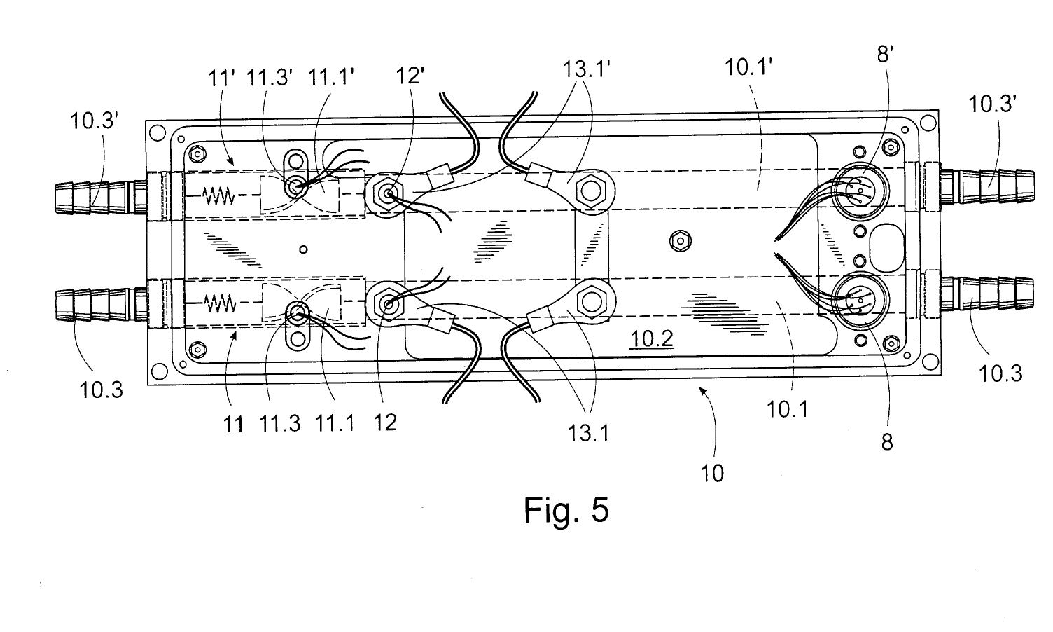

FIG. 5 shows a top view of the detector unit of FIG. 4

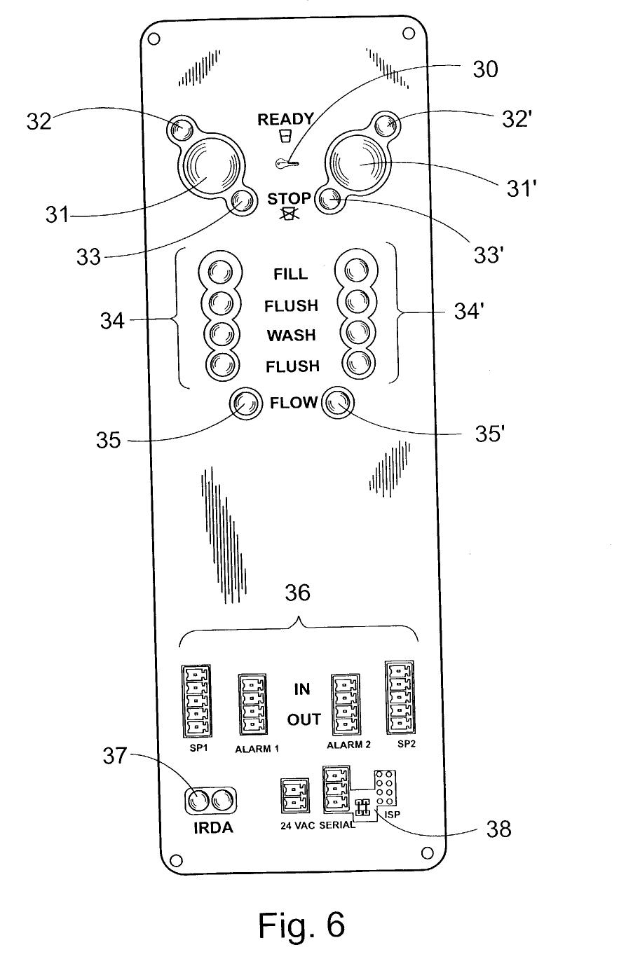

FIG. 6 shows the interface of the control unit connected to the detector unit.

In FIG. 1, the beverage is led from a tank 30 to the feed tubes 26. A three-way valve 28 controlled by an operating device (or a corresponding shut-off valve group) and a shut-off valve for closing the tank beverage feed are connected to the beverage feed end of the tubes 26 at the so-called tube bend 21 of the main tank, for the cleaning fluid dosing devices 22-24. When the beverage is dispensed, the three-way valve is closed to the cleaning fluid feed and the beverage is led under pressure from the tank 30 through a detector unit 10 and a valve unit 14 to a cooler 16 and from there to the circulation line 17, to which several dispensing taps 18 are connected. The circulation line 17 continues through a second channel in the detector unit 10 to a new circuit, which is maintained by means of a pump 15. Distribution takes place by means of its own unit 19, which is used to dispense the beverage, by means of a local volume-flow meter 27, through a valve 18.1 in doses of a set amount.

The detector unit 10 includes two fluid channels, in which are installed conductivity electrodes 13.1, 13.1′, thermometers 12, 12′, and flow meters 11, 11′, in addition to the micro card required to operate them. This makes the unit easy to service and compact. Preferably, the pressure sensor is installed in the same unit. Pressure sensing is used to set an additional alarm criteria.

According to FIG. 1, the invention operates as follows. The system is programmed, for example, so that at set intervals the controller 25 is used to run a program, by means of which the three-way valve 28 and the large tank shut-off valve contained in the tube bend 21 shut off the flow of beverage, and the three-way valve 28 opens a cleaning solution and/or a water solution connection to the tubes. First of all, the line is filled with water, which can be detected by the fluid coming from the circulation line 17 being identified from its conductivity by a conductivity measuring member 13 located in the detector unit 10. Next, the distribution tubes are filled for a set time with a 2-percent cleaning fluid from a mixing device 22 by taking, 100-percent cleaning fluid from a tank 23 and water from the line 24 in the requisite ratio. The cleaning fluid is also detected using a conductivity measurement. After this, the outlet valves 14.1 and 14.2 in the valve unit 14 are opened, the cleaning fluid is pumped into the drains 9 and the distribution tubes are flushed with water 24 once or several times. After flushing, the three-way valve 28 in the tube bend 21 is closed to the cleaning and flushing fluid feed, the shut-off valve in the main tank tube bend 21 is opened and the distribution tubes are filled with alcoholic beverage, e.g., beer, led from the main tank. During filling, the flushing water is led to the drains 9, until the detector detects complete filling with beer. The parts remaining outside the circulation line 17 of the dispensing taps 18 are washed by commands given by the controller 25 to the distribution unit 19, which dispensing taps 18 drain the liquid in the line at any time within the limits permitted by the capacity of the local tap drain 9.1.

FIG. 2a shows a system corresponding to FIG. 1, in the case of a set of direct distribution tubes. During cleaning, the line is filled with cleaning fluid by driving the beverage out of the whole line into the drain 9 through the outlet valve 18.2 of the tap 18. The next length after the outlet valve 18.2 of the tap 18 is flushed after cleaning with the beverage being distributed, this more thorough cleaning taking place during the separate cleaning of the dispensing tap 18. In this case, detectors 13′ and 13 and flow meters 11′ and 11 are used at both the feed and outlet ends, to ensure that the cleaning is carried out and can be repeated. The detection of fluids at the feed end and the monitoring of the flow quantities make it possible to supervise the progress of the process programmatically.

In the double sensor unit according to FIG. 2b, only one of the lines is used. The flow meter 11, the thermometer 12, and the sensor 13 of the second line are in use in the detector unit 10. In the direct line, each, or the most distant tap 18 is equipped with conductivity measurement. At its simplest, it is sufficient if only the sensor 13 is used.

In the system according to FIG. 3, the beverage is led to distribution through a foam detector 38. This is also used in connection with changing the main tank 30, when conductivity measurement is used to detect beverage going to the aerator channel 31, in which case the aerator valve 29 is closed and distribution can commence normally.

According to FIG. 1, the use of the detector unit 10, which includes the flow meter 11, the thermometer 12, and the sensor 13, which is formed by two sequential electrodes 13.1 set in the channel, between which the potential or current/voltage ratio is measured, is essential in terms of the invention. The fact that the different classes of liquid, i.e. water, cleaning solution, and beer or similar, are identified by their electrical conductivity is also essential to the automatic cleaning system. This controls the microprocessor or similar computer 25.

The temperature gauge 12 is required to identity the liquids on the basis of their varying conductivities at different temperatures. As such, it is possible to use some known identification method, (for example, multiple electrodes), as described in U.S. Pat. No. 5,217,112 or 5,830,343.

FIGS. 4 and 5 show details of the preferred construction of the detector unit 10. It includes a body 10.2 with two liquid channels 10.1 and 10.1′ formed in it with their connections 10.3, 10.3′. Flow meters 11, 111, conductivity electrodes 13.1, 13.1′, and pressure sensors 8, 8′ are installed in these. A thermometer sensor 12 and 12′ is installed in one conductivity electrode of each channel. The distance L between the conductivity electrodes 13.1 is about six times the diameter D of the channel (generally L/D is in the range 4-8). The inset in FIG. 4 shows their construction in greater detail. The conductivity electrode includes a screw component 13.2, a seal 13.4, and the actual electrode point 13.3. In this case, the screw component with its electrode is manufactured from acids resistant steel, but the electrode can also be made of a noble metal. The screw component 13.2 has a recess for the temperature sensor 12. The rotating spiral vane 11.1 in the flow meter cuts a beam of light (LED lamp 11.2 and sensor 11.3).

As can be seen from FIG. 4, the detector unit has space for the requisite control electronics, the interface of which is shown in FIG. 6. This also forms the cover of the detector unit. The unit includes a wireless code key 30, which is used near to the sensor point. Both lines have membrane switches 31, 31′ and operating state indicator lights 32, 32′ ‘READY’ and 33, 33′ ‘STOP’. The stages of the cleaning program are shown by lights 34 and 34′ and the normal state by lights 35 and 35′. The unit is connected to the rest of the system by means of connectors 36. Data transfer can take place through either an infrared connection 37 or a series bus 38.

Cleaning takes place according to the following program. First of all, the product line connector is moved from the tank to the cleaning connector and the drainage is checked.

Defining the Cleaning Program

The cleaning program is started with the service key (wireless connection) and either the left-hand or right-hand cleaning program or the left-hand for cleaning the circulation is selected. The selected side is activated. The selection of the cleaning program continues with the same switch: all stages, one stage, or stop (LED lights 34, 34′). The selection is confirmed with the service key.

Cleaning

During cleaning, the indicator lights 34, 34′ show the stage at which the cleaning program is: filling (FILL), first flushing (FLUSH), cleaning (CLEAN), and second flushing (FLUSH).

Final Flushing

If an automatic cleaning connector is not being used, the cleaning program stops after the second flushing. The connector is moved back to the tank and the cleaning program is continued.

Line Run

The cleaning is completed after the line run (FLOW). A check is made that there are no alarms and that the dispensers are in the normal state.

1. A method for cleaning beverage tubes, in which the set of beverage tubes includes a set of tubes (17, 26) from a tank (30) to one or several dispensing devices (18), and possible cooling, amount calculating, or other devices (11, 12, 15, 16), and in which the set of distribution tubes is cleaned in the following stages:
cleaning fluid is fed into the tubes from one end and the liquid already in the tubes is drained out of the opposite end,
the cleaning fluid is allowed to act for a set time,
the cleaning fluid is flushed out with flushing fluid by feeding in a corresponding manner in to the tubes and draining the cleaning fluid out,
the line is filled with the beverage being distributed, at the same time draining the flushing fluid out of the line, characterized in that
at least the cleaning and flushing fluids are identified by means of their electrical properties from the end of the tubes opposite to the feed, and this feed is terminated by set criteria, after which the process goes on to the next stage.

2. A method according to claim 1, characterized in that the identification takes place on the basis of the electrical conductivity of the liquid.

3. A method according to claim 2, characterized in that the temperature (12) of the liquid flowing in the line is measured in the vicinity of the measurement of electrical conductivity.

4. A method according to any of claims 1-3, characterized in that the feed of each fluid and/or the emptying of the line takes place through a valve (28, 14.1 and 14.2) controlled by an operating device.

5. A method according to claim 1, characterized in that the flow amount (11) in the line is measured.

6. A method according to claim 1, characterized in that the cleaning and flushing fluid (22) is formed either by mixing a predetermined share of cleaning fluid (23) into the pure water feed (24) or by leading the water feed (24) as such into the tubes.

7. A method according to any of claims 1-6 in the cleaning of distribution tubes comprising circulation tubes (17), in which the distribution tubes include a feed line (26) for feeding the beverage to the circulation tubes (17), characterized in that each fluid is identified both in the feed line (26) and the circulation tubes (17) according to which the process stages are controlled.

8. A system for cleaning beverage tubes, in which the set of beverage tubes includes a set of tubes (17, 26) from a tank (30) to one or several dispensing devices (18), and possible cooling, amount calculating, or other devices (11, 12, 15, 16), and in which the set of distribution tubes is cleaned in the following stages:
cleaning fluid is fed into the tubes from one end and the liquid already in the tubes is drained out of the opposite end,
the cleaning fluid is allowed to act for a set time,
the cleaning fluid is flushed out with flushing fluid by feeding in a corresponding manner in to the tubes and draining the cleaning fluid out,
the line is filled with the beverage being dispensed at the same time draining the flushing fluid out of the line, characterized in that
the system includes a controlled cleaning fluid feed connection (21) at one end of the line and one or several controlled cleaning fluid outlet connection (14.1, 14.2) at the opposite end, devices for identifying the fluid located close (10) to the outlet connection, a cleaning fluid dosing and mixing apparatus (22), and a control unit (25) controlling the cleaning.

9. A system according to claim 8, characterized in that the controlled feed connection (21) includes a shut-off valve (28) controlled by an operating device for feeding cleaning and flushing fluid (22) into the tubes.

10. A system according to claim 8, characterized in that there are one or several shut-off valves (14.1, 14.2) controlled by operating devices as controlled outlet connections, which are arranged to lead the fluid into a drain (9).

11. A system according to claim 8, characterized in that it includes a detector unit (10), which includes two fluid channels and electrical conductivity detectors (13 and 13′) fitted to them, which are connected to the beginning and correspondingly to the end of the distribution tubes.

12. A system according to claim 8, characterized in that the air that enters the tubes in connection with the changing of the beverage tank (30) is arranged to be led out with the aid of a detector (13) measuring the electrical conductivity of the fluid.

13. A detector unit (10) for installation in beverage distribution tubes, which includes a fluid channel and a flow meter (11), characterized in that the detector unit (10) also includes a temperature sensor (12) and at least two electrodes (13.1) extending into the fluid channel for measuring the electrical properties of the fluid, such as its electrical conductivity, and the detector unit (10) is constructed as a compact component also including a common electronic circuit card.

14. A system according to claim 13, characterized in that the detector unit (10) includes a pressure sensor (8).
